(19) United States
(12) Patent Application Publication
(10) Pub. No.: US 2026/0288928 A1
(43) Pub. Date: Sep. 24, 2026

(54) VEHICLE INFORMATION MANAGEMENT DEVICE

(71) Applicant: HONDA MOTOR CO., LTD., Tokyo (JP)

(72) Inventors: Yusuke MANO, Tokyo (JP); Kei HIROHATA, Tokyo (JP); Haruka KUBO, Tokyo (JP)

(21) Appl. No.: 19/568,821

(22) Filed: Mar. 17, 2026

(30) Foreign Application Priority Data
Mar. 21, 2025 (JP) 2025-046715

(51) Int. Cl. G06F 21/35; G06F 21/32

(52) U.S. Cl. CPC G06F 21/35; G06F 21/32

(57) ABSTRACT

A vehicle information management device comprises: a user information management unit for registering vehicle owner information; a reception unit for receiving an authentication registration request from a vehicle information device mounted in a vehicle; a transmission unit for transmitting authentication code information to be displayed on the vehicle information device when the authentication registration request is received; and a control unit configured to: receive, by the reception unit, authentication code confirmation information generated by the first mobile device reading the authentication code information displayed on the vehicle information device; and, if contents of authentication registration information contained respectively in the authentication code information and in the authentication code confirmation information match and the second user identification information exists in the user information management unit, send inquiry addressed to the second user contact information for consent to performing an operation to change the authentication registration to the first user.

This application is based on and claims the benefit of priority from Japanese Patent Application No. 2025-046715, filed on 21 Mar. 2025, the content of which is incorporated herein by reference.

### BACKGROUND OF THE INVENTION

### Field of the Invention

The present invention relates to a vehicle information management device that enables a user (new owner) who has acquired a vehicle secondhand to register, in order to enjoy telematics services, his/her own user information with simple operations.

### Related Art

Telematics services are expanding for vehicle owners, such as remotely starting the vehicle's engine from a smartphone or other mobile device owned by the user, or displaying the vehicle's parking location on the user's mobile device. To utilize telematics services, users must first register their vehicle and user identification information with a telematics server or the like for authentication.

The authentication registration process for such vehicle and user identification information was conventionally performed at vehicle dealerships. However, to reduce the burden on dealerships as well as users, a system has been developed that allows users to perform the authentication registration process with simple operations using their own mobile devices.

For example, Patent Document 1 discloses an authentication registration system comprising an in-vehicle controller mounted in a vehicle, a user's mobile device, and a registration server that authenticates and registers the vehicle's identification information and the user's mobile device's identification information, wherein the registration server transmits an authentication code signal containing, as data, an authentication code to the vehicle; the vehicle extracts the authentication code from the received authentication code signal and displays it on the Display Audio (DA) device; the user inputs the authentication code displayed on the DA device into his/her mobile device; the mobile device transmits an authentication code confirmation signal containing, as data, the inputted authentication code transmitted to the registration server; the registration server determines that the identification information authentication has succeeded when the authentication code in the authentication code confirmation signal transmitted from the user's mobile device matches the authentication code in the authentication code signal.

Furthermore, Patent Document 2 discloses a digital key system for vehicle comprising a device for vehicle mounted on a vehicle; a mobile device; and a server that generates a service key unique to each mobile device and transmits it to the mobile device, wherein, based on an input of a specific owner registration start signal from a predetermined dedicated device or server, the digital key system for vehicle initiates an owner registration capable mode of registering a service key (owner key) that grants authority as the vehicle owner.

Patent Document 1: Japanese Patent No. 6913141

Patent Document 2: Japanese Patent No. 7550124

### SUMMARY OF THE INVENTION

The technology described in Patent Document 1 is intended solely for the event of initially registering a new vehicle. However, naturally, users who acquire vehicles secondhand also have a need for telematics services. When a user who has acquired a used vehicle (a new owner) wishes to use the service, it is necessary to perform an authentication registration process for the owner information linked to the vehicle, including the new owner's user identification information.

However, the sale of used vehicles does not necessarily occur through authorized dealerships; it may also be conducted through used car dealers or through private sales or similar arrangements. In such cases, the user (former owner) who sold the used vehicle or the used car dealer may need to deregister the previous authentication registration after the sale. However, this deregistration is sometimes not performed due to reasons such as it being time-consuming and/or troublesome. If the previous authentication registration has not been deregistered, issues may arise, such as the vehicle location driven by the new owner being visible on the previous owner's mobile device.

Furthermore, the technology described in Patent Document 2 required inputting a specific owner registration start signal from a designated dedicated device or server to initiate processing for registering an owner key with owner privileges on a mobile device owned by the vehicle owner. This inevitably led to increased system complexity and/or cumbersome processing.

Accordingly, a new arrangement has been needed that would allow the new owner's user information to be easily and conveniently authentication registered without having to bring the vehicle acquired secondhand to an authorized dealership.

The present invention aims to provide a vehicle information management device that enables a user who has purchased a vehicle secondhand to easily register, in order to enjoy telematics services, his/her user information with simple operations.
(1) A vehicle information management device of the present invention (for example, “management server 2” described later) comprises: a user information management unit (for example, “vehicle/user information management unit 211” described later) configured to register owner information pertaining to a vehicle (for example, “vehicle 6” described later) including user identification information and contact details for a user; a reception unit (for example, “reception unit 232” described later) configured to receive an authentication registration request from either a first mobile device (for example, “mobile device 3-1” described later) held by a first user who becomes a new owner of the vehicle or a vehicle information device mounted in the vehicle (for example, “in-vehicle controller 4” and “IVI device 5” described later); a transmission unit (for example, “transmission unit 231” described later) configured to transmit, to the vehicle information device, authentication code information to be displayed on the vehicle information device when the authentication registration request is received; a control unit (for example, “control unit 212” described later) configured to: receive, by the reception unit, authentication code confirmation information, which is information generated by the first mobile device reading the authentication code information displayed on the vehicle information device; search, from the user information management unit, for a presence of second user identification information, which is identification information of a second user who is the previous owner of the vehicle, if it is confirmed that contents of authentication registration information contained respectively in the authentication code information and in the authentication code confirmation information match; and if the second user identification information exists, send inquiry, via the transmission unit, addressed to the second user contact information, which is the contact point for a second mobile device (for example, “mobile device 3-2” described later) held by the second user, asking whether to consent for the operation to change the authentication registration to the first user.
(2) In the vehicle information management device according to (1), the user information management unit may further register pairing information between the vehicle information device and the second mobile device, and the transmission unit may transmit the authentication code information to the vehicle information device when the pairing information for the second mobile device exists.
(3) In the vehicle information management device according to (2), the reception unit may further receive pairing status information indicating whether the vehicle information device and the second mobile device are in a paired state, and the transmission unit may transmit the authentication code information to the vehicle information device when the pairing status information indicates that the vehicle information device and the second mobile device are not in a paired state.
(4) In the vehicle information management device according to (1), the user information management unit may further register the owner's biometric information with the owner information pertaining to the vehicle, the reception unit may further receive biometric measurement information from a biometric sensor mounted on the vehicle, and the transmission unit may transmit the authentication code information to the vehicle information device when the second user's biometric information and the biometric measurement information do not match.
(5) In the vehicle information management device according to (4), the biometric information in the user information management unit may be the owner's weight data, and the reception unit may receive weight data as the biometric measurement information from the biometric sensor installed in a driver's seat of the vehicle.
(6) In the vehicle information management device according to (4), the biometric information in the user information management unit may be the owner's facial image, and the reception unit may receive a facial image of a person seated in a driver's seat of the vehicle as the biometric measurement information.
(7) In the vehicle information management device according to any one of (1) to (6), the control unit may determine that the vehicle may have been stolen, if the reception unit receives information indicating refusal from the second mobile device as a result of the inquiry.
(8) In the vehicle information management device according to any one of (1) to (6), the control unit may register with the user information management unit to functionally restrict at least a portion of the telematics services related to the vehicle for the second mobile device, if the reception unit receives information indicating consent from the second mobile device as a result of the inquiry, or if no information is received even after a predetermined period of time has elapsed.
(9) In the vehicle information management device according to (8), the control unit may register with the user information management unit to functionally restrict all telematics services related to the vehicle for the second mobile device, if the reception unit, after a predetermined period following the inquiry has elapsed without receiving any information, and receiving the second authentication code confirmation information from the first mobile device, which constitutes the second time authentication code confirmation information received, and if it is confirmed that contents of authentication registration information contained respectively in the second authentication code confirmation information and in the authentication code information match.

The vehicle information management device of the present invention enables performing an authentication registration process for identification information for a new owner in a simplified manner without bringing a vehicle to an authorized dealer. Additionally, the vehicle information management device of the present invention enables the protection of the new owner's privacy. Furthermore, the vehicle information management device of the present invention enables simplified detection of potential theft of the vehicle.

### BRIEF DESCRIPTION OF THE DRAWINGS

FIG. 1 is a diagram illustrating the configuration of an authentication registration system including a vehicle information management device (management server) according to an embodiment of the present invention.

FIG. 2 is a block diagram illustrating the configuration of a vehicle information management device (management server) according to an embodiment of the present invention.

FIG. 3 is a block diagram illustrating the configuration of a mobile device, which is an element of the authentication registration system according to an embodiment of the present invention.

FIG. 4 is a block diagram illustrating the configuration of an in-vehicle controller, which is an element of the authentication registration system according to an embodiment of the present invention.

FIG. 5 is a diagram illustrating communication operations for authentication registration processing within the authentication registration system.

FIG. 6 is a flowchart illustrating the authentication registration process flow in the vehicle information management device (management server) according to an embodiment of the present invention.

### DETAILED DESCRIPTION OF THE INVENTION

The following describes a vehicle information management device (management server) according to an embodiment of the present invention, with reference to the drawings. The vehicle information management device (management server) of this embodiment is intended for users to register identification information related to their owned vehicles themselves, for purposes such as using telematics services.

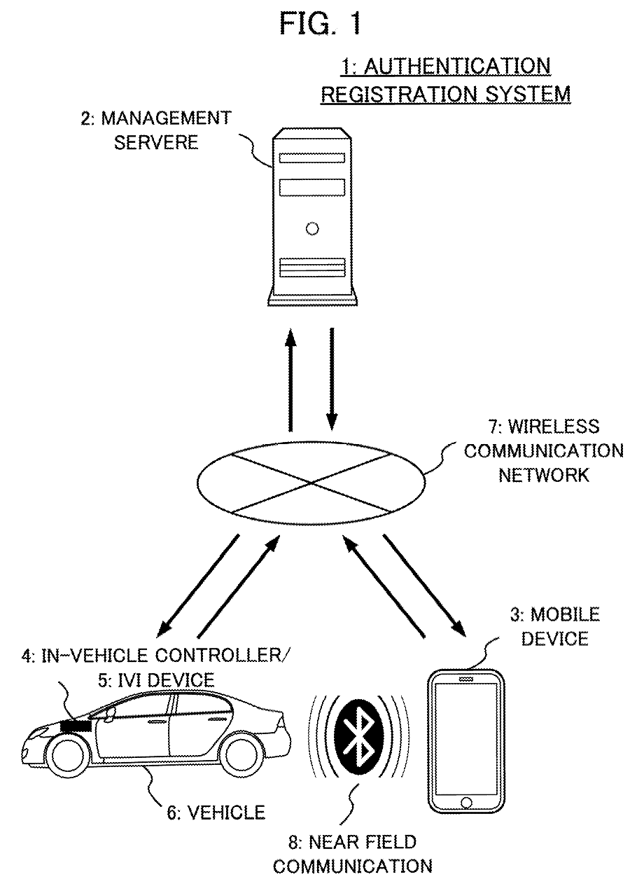

As shown in FIG. 1, the authentication registration system 1 according to this embodiment comprises at least a management server 2, a plurality of mobile devices 3 (only one shown), and an in-vehicle controller 4 and an IVI device 5 (both only one shown) mounted in a plurality of vehicles 6. These components 2 to 5 can be connected to each other for data communication via a wireless communication network 7. Additionally, the mobile device 3 and the in-vehicle controller 4 can be paired via near field communication 8.

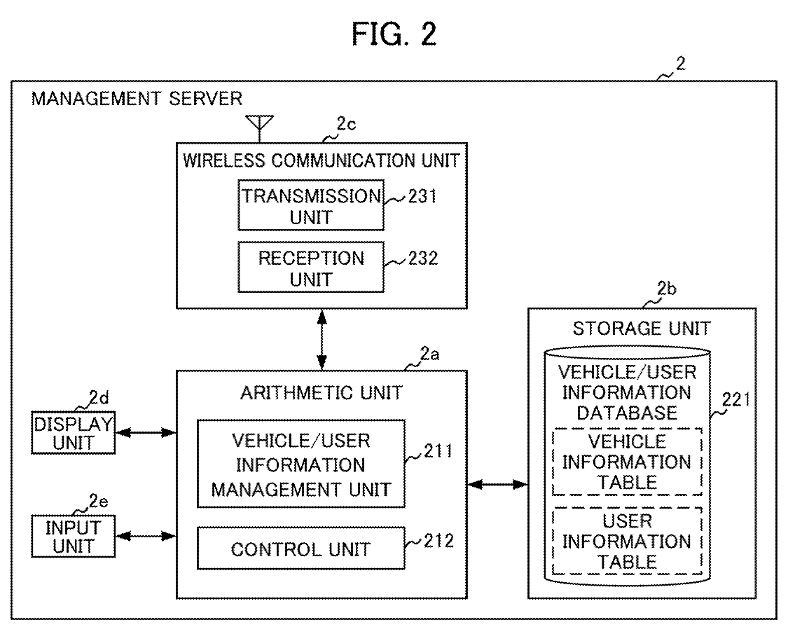

As shown in FIG. 2, the management server 2 comprises an arithmetic unit 2a, a storage unit 2b, a wireless communication unit 2c, a display unit 2d, an input unit 2e, and other components. The arithmetic unit 2a includes a vehicle/user information management unit 211, a control unit 212, and other components. Additionally, the storage unit 2b includes a vehicle/user information database 221, and other components. Here, the vehicle/user information database 221 is preferably a so-called relational database, wherein the vehicle information table and the user information table are mutually associated. If the vehicle/user information database 221 is a relational database, it becomes easy to search for user information (e.g., the owner's contact details) associated with a specific vehicle based on vehicle identification information, or to search for vehicle information associated with a specific vehicle owned by a user based on user identification information.

Additionally, the wireless communication circuit 2c includes a transmission unit 231 and a reception unit 232. It can transmit data from the transmission unit 231 to the in-vehicle controller 4 or the mobile device 3 via the wireless communication network 7, and can receive data from the in-vehicle controller 4 or the mobile device 3 via the wireless communication network 7 using the reception unit 232. Note that the management server 2 of this embodiment corresponds to the vehicle information management device of the claims.

The management server 2 can perform data communication with the mobile device 3 and the in-vehicle controller 4 via the wireless communication unit 2c and the wireless communication network 7. Then, through this data communication, authentication registration process described later is performed, and when this authentication registration succeeds, various identification information is registered (stored) in the vehicle/user information database 221 within the storage unit 2b.

Once various identification information is registered in the storage unit 2b of the management server 2, users can subsequently utilize telematics services. For example, users can operate their own mobile device 3 to perform remote operations such as starting an engine of a registered vehicle, or displaying the vehicle's parking location on the mobile device 3.

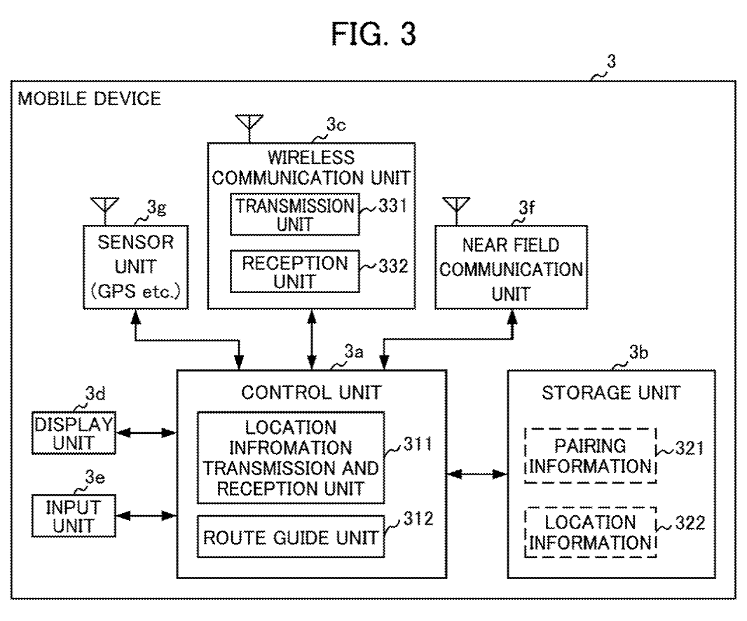

The mobile device 3 is a smartphone, a tablet, or similar devices owned by a user. As shown in FIG. 3, it includes a control unit 3a, a storage unit 3b, a wireless communication unit 3c, a display unit 3d, an input unit 3e, a near field communication unit 3f, and a sensor unit (such as GPS) 3g. The mobile device 3 is capable of connecting to the wireless communication network 7 via the wireless communication unit 3c. The wireless communication unit 3c includes a transmission unit 331 and a reception unit 332, enabling data communication with the management server 2 and the vehicle controller 4 connected via the wireless communication network 7. Then, authentication registration process described later is executed via the data communication.

The control unit 3a comprises a microcomputer equipped with a processor, memory, I/O interface, etc., and includes a location information reception unit 311, a route guide unit 312, and other components. The storage unit 3b is a storage for the control unit 3a (microcomputer), storing basic software (not shown) for operating the microcomputer, as well as pairing information 321 between the mobile device 3 and the vehicle controller 4, position information 322 acquired from the sensor unit (GPS) 3g, and other data. Pairing between the mobile device 3 and the in-vehicle controller 4 will be described later.

Additionally, the storage unit 3b of the mobile device 3 has application software for predetermined communication services (hereinafter referred to as "communication app") installed by a user. By executing the communication app, it becomes possible to perform data communication with the management server 2, as described later. This enables performing such as transmitting an authentication registration request signal described later to the management server 2 based on a user's input operation to the display unit 3d.

Additionally, a transparent touch panel is laminated onto the display unit 3d. When a user performs a specific input action (e.g., tap, swipe, pinch out, pinch in) on the touch panel, an operation signal representing that action is output to the control unit 3a. The display unit 3d with the touch panel can also function as the input unit 3e.

Furthermore, the near field communication unit 3f complies with near field communication standards such as “Bluetooth (registered trademark)”. This enables pairing between the mobile device 3 and the in-vehicle controller 4 mounted in the vehicle 6 when the user boards the vehicle 6 while carrying the mobile device 3, and allowing near field communication between them.

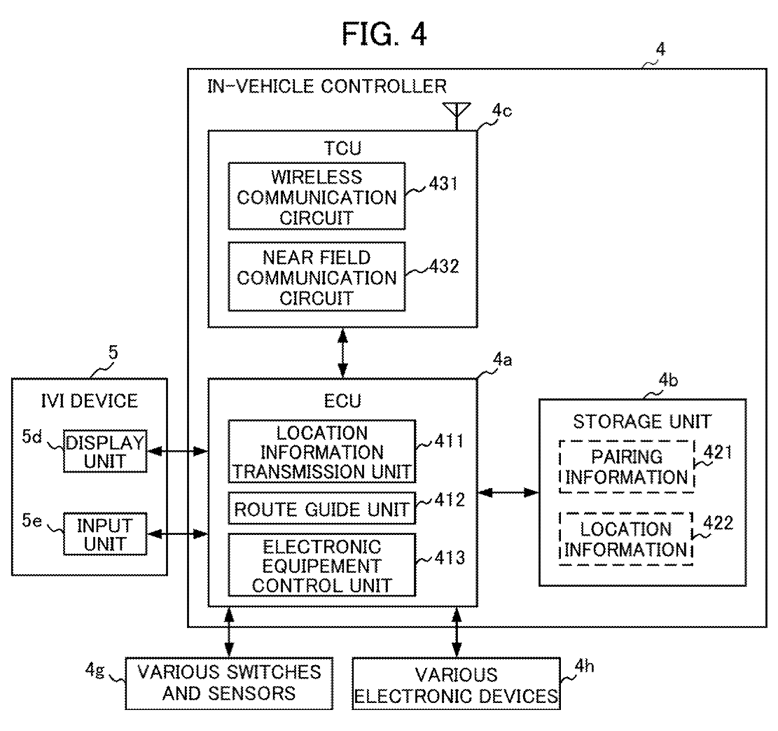

The in-vehicle controller 4 is mounted in the vehicle 6 and, as shown in FIG. 4, comprises an ECU (Electronic Control Unit) 4a, a storage unit 4b, and a TCU (Telematics Control Unit) 4c. Additionally, the in-vehicle controller 4 is connected to various external switches and sensors 4g, as well as various electronic devices 4h. Various switches and sensors include, for example, an ignition switch, a wiper switch, a light switch, a GPS sensor, a temperature sensor, a seat belt sensor, a seat (occupancy) sensor, and so on.

Both the ECU 4a and the TCU 4c are microcomputers composed of processors, storages, memories, I/O interfaces and so on. The ECU 4a includes a position information transmission unit 411, a route guide unit 412, an electronic device control unit 413, and so on. The TCU 4c includes a wireless communication circuit 431 and a near field communication circuit 432, which will be described later.

The ECU 4a is a device that controls various onboard electronic equipment. The electronic device control unit 413, based on signal inputs from various external switches and sensors (collectively labeled as various switches and sensors 4g in FIG. 4), controls, for example, an ignition, an engine (including throttles and fuel injectors), a battery, a motor, a clutch, transmission gears, differential gears, and other power/drive system components; a steering, brakes, suspensions, and other running stability/handling system components; and wipers, lights, airbags, interior/exterior monitors, an air conditioner, and other safety/environmental system components. This enables a wide range of functions, such as throttle-by-wire/traction controls, automatic idling stop controls, hybrid controls of an engine/motor, lane keeping/cruise controls/autonomous driving, anti-skid braking controls, differential gears’ slip controls, active suspension/ active height controls, various warnings for a driver, and cabin environment controls.

In contrast, the TCU 4c is a communication unit that enables bidirectional information exchange between the vehicle 6 and the outside of the vehicle 6 in response to requests, for example, from the ECU 4a. It is a key device for realizing so-called connected cars, that is, vehicles equipped with IoT (Internet of Things) device capabilities. The aforementioned telematics services (such as remotely starting an engine of the vehicle 6 from the mobile device 3, displaying a parking location of the vehicle 6 on the mobile device 3, etc.) are also realized by the ECU 4a receiving commands from the mobile device 3 via the TCU 4c and controlling various electronic devices.

The TCU 4c comprises a wireless communication circuit 431 and a near field communication circuit 432. The wireless communication circuit 431 incorporates a SIM card (not shown). This SIM card stores various information based on the contract with the telecommunications carrier, enabling the in-vehicle controller 4 to perform data communication with the vehicle information management device (management server 2) of the present invention and the mobile device 3 from the wireless communication circuit 431 of the TCU 4c via the wireless communication network 7. Then, an authentication registration process described later is performed via the data communication.

Furthermore, the near field communication circuit 432 complies with near field communication standards such as “Bluetooth (registered trademark)”. This enables the vehicle controller 4 and the mobile device 3 to pair when the user boards the vehicle 6 while carrying the mobile device 3, allowing near field communication between them.

Besides a control program of the ECU 4a (not shown), vehicle identification information and user identification information (both not shown) are also stored within the storage unit 4b. This vehicle identification information is identification information and is assigned for the vehicle 6 at the time when the vehicle 6 is manufactured. Additionally, user identification information is identification information for an owner of the vehicle 6. It is assigned, for example, when the vehicle 6 is sold to the owner, and when the vehicle 6 is sold secondhand to another owner, new user identification information is assigned for the new owner. Furthermore, based on commands from the control program within the storage unit 4b and input data from the various switches and sensors 4g, the electronic device control section 413 of the ECU 4a executes the aforementioned various control processes.

Additionally, pairing information 421, location information 422, and other data are also stored within the storage unit 4b. The route guide unit 412 of the ECU 4a periodically acquires position information 422 of the vehicle 6 from a GPS sensor included in the various switches and sensors 4g, and stores it in the storage unit 4b. Location information 422 stored in the storage unit 4b is used when the route guide unit 412 provides route guidance (car navigation) to a user via the IVI device 5. Additionally, it is transmitted to the mobile device 3 via the location information transmission unit 411 when displaying, as part of the telematics service, a parking location of the vehicle 6 on the mobile device 3.

The storage unit 4b further stores ignition on/off information (not shown) indicating a time when a user performed ignition on/off and a position of the vehicle 6 at that time. This ignition on/off information is transmitted to the management server 2 at an appropriate time and is used for providing telematics services.

The IVI device 5 is a device that works in conjunction with the in-vehicle controller 4 to provide both informational and entertaining elements. “IVI” is an abbreviation for In-Vehicle Infotainment, and “infotainment” is a portmanteau combining the words “information” and “entertainment”. The provision of informational elements includes, for example, route guidance (car navigation) and displaying of road traffic information. The provision of entertaining elements includes, for example, car audio systems, in-vehicle DVD players, TV tuners, and displaying of internet content.

The IVI device 5 includes a display unit 5d, an input unit 5e, and other components. The display unit 5d is a so-called touch panel, which consists of a transparent touchpad laminated onto a display device such as an LCD panel or an OLED panel. The display unit 5d, which is a touch panel, can also serve as the input unit 5e. Additionally, the display unit 5d can display a barcode (preferably a two-dimensional barcode such as a “QR code (registered trademark)”).

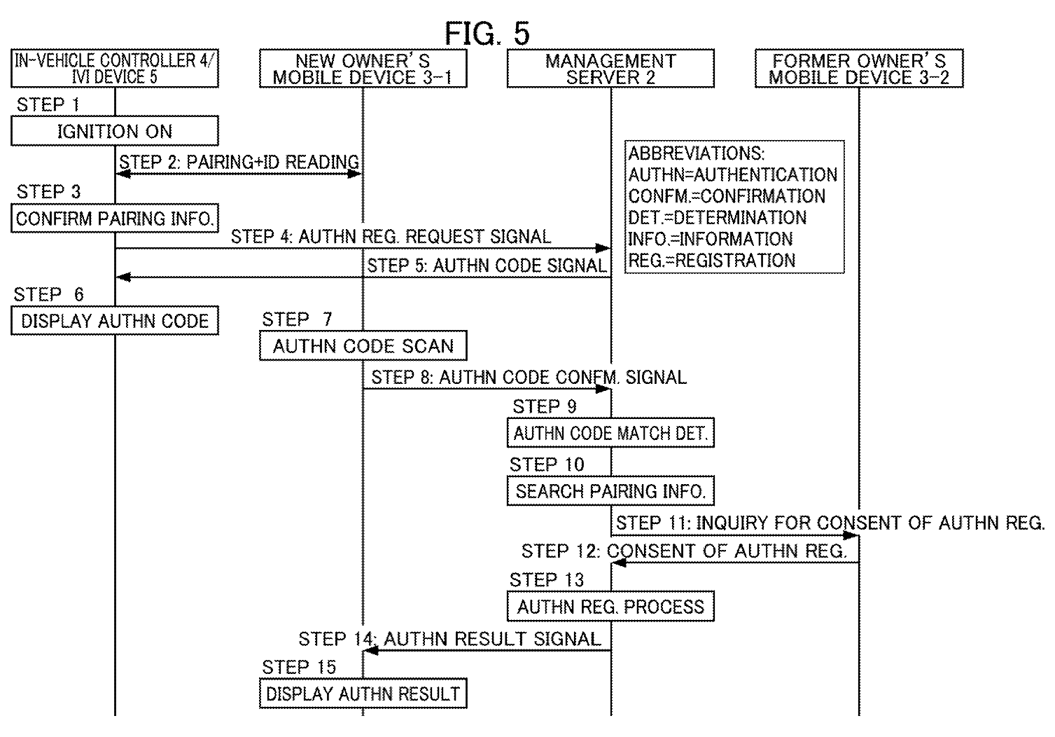

Next, communication operations, which are performed during authentication registration by the authentication registration system 1 of this embodiment, will be explained with reference to FIG. 5.

As shown in FIG. 5, when a user (new owner) who acquired the vehicle secondhand boards the vehicle with a mobile device 3-1 having the communication app installed and starts the in-vehicle controller 4 (FIG. 5/STEP 1: the in-vehicle controller 4 is activated upon ignition), the in-vehicle controller 4 automatically establishes a pairing via near field communication with the mobile device 3-1 and reads the device identification information from the mobile device 3-1 (FIG. 5/STEP 2). Subsequently, the vehicle controller 4 searches pairing information 421 within the storage unit 4b to confirm whether pairing information exists or not based on device identification information read from the paired mobile device 3-1 (FIG. 5/STEP 3).

If pairing information based on device identification information read from the mobile device 3-1 does not exist in pairing information 421 stored in the storage unit 4b, the in-vehicle controller 4 determines that the boarding user is a new owner of the vehicle 6 and transmits an authentication registration request to the management server 2 (FIG. 5/STEP 4). Alternatively, the in-vehicle controller 4 may display a message on the display unit 5d prompting a user holding the mobile device 3-1 to perform authentication registration (e.g., “Authentication registration is required to use telematics services. Access the address displayed on the screen to begin authentication registration.”), thereby causing an authentication registration request sent from the mobile device 3-1 to the management server 2. Additionally, the display unit 5d may display a message prompting a user to register for authentication along with a message prompting the user to install the communication app on the mobile device 3-1.

The management server 2 transmits an authentication code to the in-vehicle controller 4 upon receiving an authentication registration request from either the in-vehicle controller 4 or the mobile device 3-1 (FIG. 5/STEP 5). Here, the authentication code is a code used by the management server 2 to authenticate and register the mobile device 3-1, provided that the code sent to the in-vehicle controller4 and the code received from the mobile device 3-1 matches.

When the TCU 4c of the in-vehicle controller 4 receives an authentication code from the management server 2, the ECU 4a converts the authentication code into a barcode (preferably a two-dimensional barcode such as a “QR code (registered trademark)”) and displays it on the display unit 5d of the IVI device 5 (FIG. 5/STEP 6). Additionally, when converting the authentication code into a barcode, the ECU 4a lets the barcode includes address information required to access the management server 2 along with the authentication code information. Additionally, when displaying the barcode on the display unit 5d, the ECU 4a also displays a message prompting a user to launch the communication app and scan the barcode. The screen displaying the barcode and the message shown on the display unit 5d is hereinafter referred to as the “setup screen”.

When a user launches the communication app on the mobile device 3-1 and scans the barcode included in the setup screen (FIG. 5/STEP 7), the wireless communication unit 3c of the mobile device 3-1 connects to the management server 2 via the wireless communication network 7 for enabling data communication and transmits an authentication code confirmation signal based on the scanned barcode from the transmission unit 331 (FIG. 5/STEP 8). Here, the authentication code confirmation signal includes not only the authentication code contained within the scanned barcode, but also user identification information, vehicle identification information, identification information of the mobile device 3, and so on.

The control unit 213 of the processing unit 2a of the management server 2 extracts the authentication code from the authentication code confirmation signal received from the mobile device 3-1. Then, the control unit 213 determines whether the authentication code extracted from the authentication code confirmation signal received by the management server 2 from the mobile device 3-1 matches the authentication code sent by the management server 2 to the in-vehicle controller 4 (FIG. 5/STEP 9). Upon determining a match, the control unit 213 searches the vehicle/user information database 221 using the vehicle identification information as a key. It then confirms whether pairing information between the in-vehicle controller 4 and the mobile device 3-2, the mobile device 3-2 being owned by the previous owner, is already registered linked with the vehicle identification information (FIG. 5/STEP 10). If the pairing information is already registered, the control unit 213 extracts the email address, username etc., for the mobile device 3-2 (the previous owner's contact information) from the registered pairing information. It then sends, from the transmission unit 231 of the wireless communication unit 2c, an email or a message addressed to the contact information, requesting the previous owner’s consent to register user information associated with the mobile device 3-1 as linked to the vehicle 6 identified by the vehicle identification information (FIG. 5/STEP 11).

If the reception unit 232 receives an email or a message from the previous owner consenting to the registration of user information pertaining to the new owner within the predetermined time period (FIG. 5/STEP 12), the control unit 213 of the management server 2 registers the vehicle identification information, the user identification information, etc., extracted from the authentication code confirmation signal into the vehicle/user information database 221, thereby completing the authentication registration process (FIG. 5/STEP 13).

Subsequently, the registration server 2 transmits a signal indicating the authentication result to the mobile device 3-1 (FIG. 5/STEP 14). Upon receiving the signal indicating the authentication result, the mobile device 3-1 displays the authentication result on the display unit 3d for notification to the user (new owner) (FIG. 5/STEP 15).

The above describes the basic authentication registration process (hereinafter referred to as the “basic process”) performed in the authentication registration system 1. However, several optional processes are performable, so their details are explained below.

First, in the basic process's STEP 5, the management server 2 transmits an authentication code to the in-vehicle controller 4 upon receiving an authentication registration request from either the in-vehicle controller 4 or the mobile device 3-1. However, the search for pairing information performed in the basic process's STEP 10 may be moved forward to STEP 5, and the authentication code may be sent to the in-vehicle controller 4 only when pairing information with the mobile device 3-2 exists.

In other words, at STEP 5, the first pairing has been established between the in-vehicle controller 4 and the mobile device 3-1 belonging to someone who has boarded the vehicle 6, and if it is known that pairing information between the in-vehicle controller 4 and the mobile device 3-2 owned by the previous owner is already stored at that step, it becomes possible to infer that the owner of the mobile device 3-1 currently paired is likely the new owner of the vehicle 6. In this way, displaying the setup screen only when the new owner's mobile device 3-1 is detected boarding the vehicle 6 allows the new owner to easily and conveniently complete the authentication registration and enjoy telematics services. At the same time, it prevents unnecessary setup screen displays when the one boarding the vehicle 6 is not a new owner, thereby avoiding the one being bothered.

Additionally, in STEP 5, the management server 2 may further receive pairing status information from the in-vehicle controller 4 indicating whether the in-vehicle controller 4 and the mobile device 3-2 are currently paired, and the management server 2 may transmit an authentication code to the in-vehicle controller 4 only when the received pairing status information indicates that the in-vehicle controller 4 and the mobile device 3-2 are not currently paired.

In other words, if the pairing status information indicates that the in-vehicle controller 4 and the mobile device 3-2 are currently paired, it means that the mobile device 3-2, owned by a user presumed to be the owner of the vehicle 6, is present inside the vehicle 6, and at the same time, a different mobile device 3-1 is paired with the in-vehicle controller 4, this indicates that the owner of the vehicle 6 has not changed, and it can be inferred that the mobile device 3-1 owned by someone who boarded the vehicle 6 with the owner (a passenger) happened to pair with the in-vehicle controller 4. In such cases, by not transmitting the authentication code to the in-vehicle controller 4 (and not displaying the setup screen), it is possible to prevent the owner and the passenger from being bothered by unnecessary displays.

Additionally, the sensor 6g equipped on the vehicle 6 may include a biometric sensor, and user information registered in the vehicle/user information database 221 of the management server 2 may also include user's biometric information. In addition to that, in STEP 5, the reception unit 232 of the management server 2 may receive additional biometric information of a user boarding the vehicle 6, measured by the biometric sensor 6g equipped on the vehicle 6. Only when this received biometric information does not match the biometric information of the user registered in the vehicle/user information management unit 211, the transmitting unit 231 of the management server 2 may transmits an authentication code to the in-vehicle controller 4.

That is, if the mismatch in biometric information suggests that the user who boarded the vehicle 6 is not the registered user (the owner of the vehicle 6), then conversely, only when it can be inferred that the user who boarded is likely a new owner, the authentication code is sent to the in-vehicle controller 4 to display the setup screen. This allows the new owners to easily and conveniently complete authentication registration and enjoy telematics services, while preventing unnecessary setup screens from appearing on the display unit and causing annoyance when a new owner does not board the vehicle 6.

Alternatively, the biometric information registered in the vehicle/user information management unit 211 of the management server 2 may be a user's weight data. The vehicle 6 may be equipped with a biometric measurement sensor 6g that includes a seat sensor capable of measuring a weight of a user seated in the driver's seat. The weight data detected by this seat sensor may then be compared with the weight data registered in the vehicle/user information management unit 211.

Alternatively, the biometric information registered in the vehicle/user information management unit 211 of the management server 2 may be a user's facial image. The vehicle 6 may include a biometric sensor 6g and an in-vehicle camera capable of capturing a front-facial image of a user seated in the driver's seat. The facial image extracted from the image captured by the in-vehicle camera may then be compared with the facial image registered in the vehicle/user information management unit 211.

Additionally, in STEP 12 of the basic process, if the management server 2 receives an email or a message from the mobile device 3-2 indicating refusal of the authentication registration, it may restrict the functions of the vehicle 6, for example, by preventing an engine/motor from starting. Alternatively, if the content of an email or a message from mobile device 3-2 strongly suggests that the vehicle 6 has been stolen, emergency notification procedures to police authorities, insurance companies, etc., may be initiated.

Additionally, after the management server 2 inquires the mobile device 3-2 about the authentication registration of user information pertaining to the mobile device 3-1 in STEP 11 of the basic process, in STEP 12 of the basic process, upon receiving an email or a message indicating acceptance of the authentication registration from the mobile device 3-2, or if no such email or message is received even after a predetermined time has elapsed, the management server 2 may register, in the vehicle/user information database 221, information indicating that at least part of the telematics services related to the vehicle 6 shall be functionally restricted for the mobile device 3-2.

In other words, if an email or a message confirming acceptance of the authentication registration is received from the mobile device 3-2 (owned by the previous owner), it is certain that the owner of the vehicle 6 has changed. Therefore, there is no problem to restrict the functionality of telematics services related to the vehicle 6 for the mobile device 3-2 owned by the previous owner. Furthermore, if the owner of the vehicle 6 has not changed, it is highly probable that an email or a message indicating refusal of the authentication registration will be received from the mobile device 3-2. Conversely, if no such email or message is received even after a predetermined period has elapsed, it can be inferred that the owner of the vehicle 6 has changed. Therefore, if no email or message is received after a predetermined period has elapsed, at least some of the telematics services related to the vehicle 6 will be functionally restricted for the mobile device 3-2. This may prevent a problem, such as the current location of the vehicle 6 driven by the new owner being visible on the previous owner's mobile device, occurs.

Additionally, after the management server 2 inquires the mobile device 3-2 about the authentication registration of user information pertaining to the mobile device 3-1 in STEP 11 of the basic process, if it receives no email or message from the mobile device 3-2 but receives a second authentication code confirmation signal from the mobile device 3-1, and determines that the authentication code extracted from the second authentication code confirmation signal matches the authentication code sent to the in-vehicle controller 4 in STEP 5, it may register information in the vehicle/user information database 221 indicating that all telematics services related to the vehicle 6 for mobile device 3-2 shall be functionally restricted.

The fact that a second authentication code confirmation signal was received and the authentication code was determined to match after a predetermined period had elapsed since the first authentication code confirmation signal was received and the authentication code was determined to match can be seen to indicate that the user possessing the mobile device 3-1 has continued to manage the vehicle 6 at least during the predetermined period. Furthermore, considering that no email or message declining the authentication registration was received from the mobile device 3-2 in this case, it is highly probable that the owner of vehicle 6 has changed. Therefore, by functionally restricting all telematics services related to the vehicle 6 on the mobile device 3-2 owned by the previous owner, issues such as the current location of the vehicle driven by the new owner being visible on the previous owner's mobile device can be prevented.

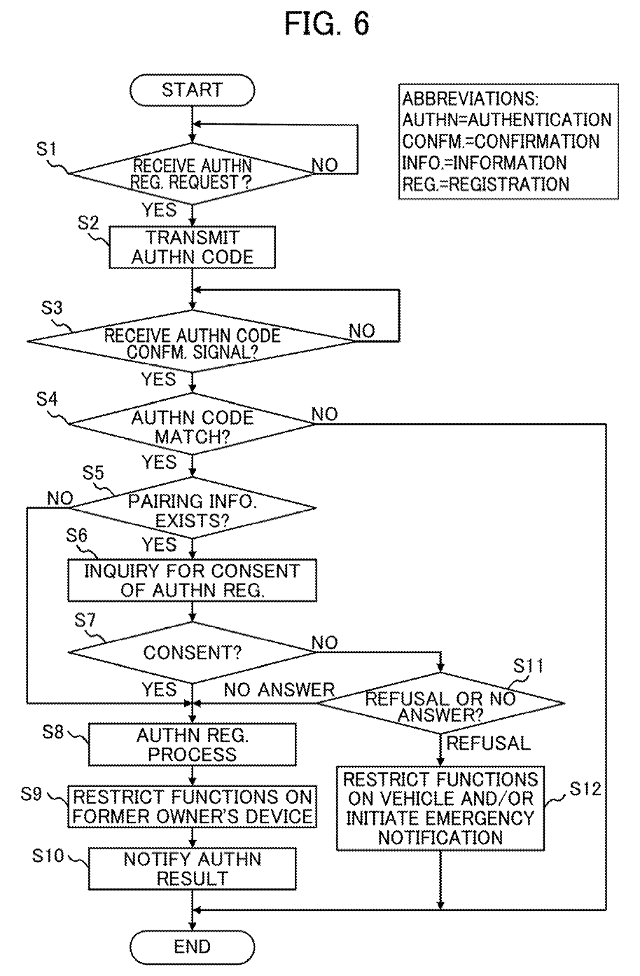

An example of the authentication registration process flow in the management server 2 according to this embodiment is explained using a flowchart in FIG. 6.

When the management server 2 receives an authentication registration request from either the in-vehicle controller 4 or the mobile device 3-1 (YES in FIG. 6/S1), it transmits an authentication code signal to the in-vehicle controller 4 (FIG. 6/S2).

Next, when the management server 2 receives an authentication code confirmation signal from the mobile device 3-1 (YES in FIG. 6/S3), it determines whether the authentication code extracted from the authentication code confirmation signal received by the management server 2 from the mobile device 3-1 matches the authentication code sent by the management server 2 to the in-vehicle controller 4 (FIG. 6/S4). If the authentication code matches (YES in FIG. 6/S4), the vehicle/user information database 221 is searched to confirm whether pairing information between the in-vehicle controller 4 and the mobile device 3-2 owned by the previous owner is already registered (FIG. 6/S5). If pairing information has already been registered (YES in FIG. 6/S5), the management server 2 sends an inquiry to the mobile device 3-2 for consent to registering the user information pertaining to the mobile device 3-1 (FIG. 6/S6). When a consent response is received from the mobile device 3-2 (YES in FIG. 6/S7), the management server 2 register the vehicle identification information, the user identification information, etc., in the vehicle/user information database 221 to complete the authentication registration (FIG. 6/S8).

Subsequently, the management server 2 restricts the telematics service functions related to the vehicle 6 for the mobile device 3-2 (FIG. 6/S9), notifies the mobile device 3-1 of the authentication result (FIG. 6/S10), and terminates the authentication registration process. If the authentication code extracted from the authentication code confirmation signal received by the management server 2 from the mobile device 3-1 does not match the authentication code sent by the management server 2 to the in-vehicle controller 4 (NO in FIG. 6/S4), the process terminates without performing authentication registration. Additionally, if the pairing information between the vehicle controller 4 and the mobile device 3-2 was not registered in the vehicle/user information database 221 (NO in FIG. 6/S5), an authentication registration process is performed (FIG. 6/S8). Subsequently, the process proceeds to FIG. 6/S9 and S10 and terminates.

The management server 2 sends an inquiry to the mobile device 3-2 for consent to register user information related to the mobile device 3-1 (FIG. 6/S6). If no consent response is received from the mobile device 3-2 (FIG. 6/S7: NO), subsequent processing differs depending on whether no response was received within a predetermined period (FIG. 6/S11: No response) or a response refusing registration was received (FIG. 6/S11: Refusal). In the former case (FIG. 6/S11: No response), the authentication registration process is performed (FIG. 6/S8), then proceeds to FIG. 6/S9 and S10 to complete processing. In the latter case (FIG. 6/S11: Refusal), functions of the vehicle 6 are restricted (e.g., preventing the engine/motor from starting) and/or notification is made to police authorities, insurance companies, etc., (FIG. 6/S12), then the process is terminated.

### Modifications

The above-described embodiments and several options are all preferred embodiments of the present invention. However, the technical scope of the present invention is not limited to these embodiments alone. Various modifications may be made within the scope of the present invention without departing from its essence.

For example, in case where no email or message is received from the mobile device 3-2 even after a predetermined period has elapsed after inquiring about the authentication registration of user information pertaining to the mobile device 3-1, multiple predetermined periods may be set, and as time passes, the functional restrictions on telematics services related to the vehicle 6 for the mobile device 3-2 may be progressively strengthened.

### EXPLANATION OF REFERENCE NUMERALS

1 registration system

2 management server

2a arithmetic unit

211 vehicle/user information management unit

212 control unit

2b storage unit

221 vehicle/user information database

2c wireless communication unit

231 transmission unit

232 reception unit

2d display unit

2e input unit

3 mobile device

3a control unit

311 location information transmission and reception unit

312 route guide unit

3b storage unit

321 pairing information

322 location information

3c wireless communication unit

331 transmission unit

332 reception unit

3d display unit

3e input unit

3f near field communication unit

3g sensor unit

4 in-vehicle controller

4a ECU (Electronic Control Unit)

411 location information transmission unit

412 route guide unit

413 electronic equipment control unit

4b storage unit

421 pairing information

422 location information

4c TCU (Telematics Control Unit)

431 wireless communication circuit

432 near field communication circuit

4g various switches and sensors

4h various electronic devices

5 IVI (In-Vehicle Infotainment) device

5d display unit

5e input unit

6 vehicle

7 wireless communication network

8 near field communication

What is claimed is:

1. A vehicle information management device comprising:
a user information management unit configured to register owner information pertaining to a vehicle including user identification information and contact details for a user;
a reception unit configured to receive an authentication registration request from either a first mobile device held by a first user who becomes a new owner of the vehicle or a vehicle information device mounted in the vehicle;
a transmission unit configured to transmit, to the vehicle information device, authentication code information to be displayed on the vehicle information device when the authentication registration request is received;
a control unit configured to: receive, by the reception unit, authentication code confirmation information, which is information generated by the first mobile device reading the authentication code information displayed on the vehicle information device; search, from the user information management unit, for a presence of second user identification information, which is identification information of a second user who is the previous owner of the vehicle, if it is confirmed that contents of authentication registration information contained respectively in the authentication code information and in the authentication code confirmation information match; and if the second user identification information exists, send inquiry, via the transmission unit, addressed to the second user contact information, which is the contact point for a second mobile device held by the second user, asking whether to consent for the operation to change the authentication registration to the first user.

2. The vehicle information management device according to claim 1, wherein
the user information management unit further registers pairing information between the vehicle information device and the second mobile device, and
the transmission unit transmits the authentication code information to the vehicle information device when the pairing information for the second mobile device exists.

3. The vehicle information management device according to claim 2, wherein
the reception unit further receives pairing status information indicating whether the vehicle information device and the second mobile device are in a paired state, and
the transmission unit transmits the authentication code information to the vehicle information device when the pairing status information indicates that the vehicle information device and the second mobile device are not in a paired state.

4. The vehicle information management device according to claim 1, wherein
the user information management unit further registers the owner's biometric information with the owner information pertaining to the vehicle,
the reception unit further receives biometric measurement information from a biometric sensor mounted on the vehicle, and
the transmission unit transmits the authentication code information to the vehicle information device when the second user's biometric information and the biometric measurement information do not match.

5. The vehicle information management device according to claim 4, wherein
the biometric information in the user information management unit is the owner's weight data, and
the reception unit receives weight data as the biometric measurement information from the biometric sensor installed in a driver's seat of the vehicle.

6. The vehicle information management device according to claim 4, wherein
the biometric information in the user information management unit is the owner's facial image, and
the reception unit receives a facial image of a person seated in a driver's seat of the vehicle as the biometric measurement information.

7. The vehicle information management device according to claim 1, wherein
the control unit determines that the vehicle may have been stolen, if the reception unit receives information indicating refusal from the second mobile device as a result of the inquiry.

8. The vehicle information management device according to claim 1, wherein
the control unit registers with the user information management unit to functionally restrict at least a portion of the telematics services related to the vehicle for the second mobile device, if the reception unit receives information indicating consent from the second mobile device as a result of the inquiry, or if no information is received even after a predetermined period of time has elapsed.

9. The vehicle information management device according to claim 8, wherein
the control unit registers with the user information management unit to functionally restrict all telematics services related to the vehicle for the second mobile device, if the reception unit, after a predetermined period following the inquiry has elapsed without receiving any information, and receiving the second authentication code confirmation information from the first mobile device, which constitutes the second time authentication code confirmation information received, and if it is confirmed that contents of authentication registration information contained respectively in the second authentication code confirmation information and in the authentication code information match.
